(19) United States
(12) Patent Application Publication
(10) Pub. No.: US 2009/0078904 A1
(43) Pub. Date: Mar. 26, 2009

(54) Side valve

(75) Inventor: Lutz Lange, Ludenscheid (DE)

Correspondence Address: COLLARD & ROE, P.C., 1077 NORTHERN BOULEVARD, ROSLYN, NY, 11576, US

(73) Assignee: Fluhs Drehtechnik GmbH

(21) Appl. No.: 12/012,776

(22) Filed: Feb. 5, 2008

(30) Foreign Application Priority Data
Sep. 26, 2007 (EP) 07018883.4

(51) Int. Cl. F16K 27/00

(52) U.S. Cl. 251/366

(57) ABSTRACT

A side valve includes an outer sleeve into which a connector piece is introduced, on the side, as well as an inner sleeve that is introduced into the outer sleeve and that has a connector piece for a connection to the water supply, whereby a groove for accommodating a sealing ring is disposed adjacent to the attachment section, on its side facing away from the connector piece. In another embodiment, a side valve includes an outer sleeve into which a connector piece is affixed on the side, whereby a support surface for a sealing ring is disposed at the base of the opening disposed in the outer sleeve, on the side, for accommodating the connector piece.

### CROSS REFERENCE TO RELATED APPLICATIONS

Applicant claims priority under 35 U.S.C. §119 of European Application 07018883.4 filed Sep. 26, 2007.

### BACKGROUND OF THE INVENTION

1. Field of the Invention

The present invention relates to a side valve including an outer sleeve into which a connector piece is introduced on the side. The side valve also includes an inner sleeve that is introduced into the outer sleeve and that has a connector piece for a connection to the water supply. The invention furthermore relates to a side valve including an outer sleeve into which a connector piece is affixed on the side.

2. The Prior Art

The exit of media from fittings, with simultaneous deflection of the flow direction, is controlled using side valves. Known side valves include an outer sleeve into which a connector piece is affixed on the side, as well as an inner sleeve that is introduced longitudinally into the outer sleeve. In this way, an interstice is formed between inner sleeve and outer sleeve. The inner sleeve accommodates an upper valve part, by way of which the inflow amount can be controlled. The inner sleeve and the connector piece are screwed to the outer sleeve, with the use of a sealing adhesive, whereby the sealing adhesive is applied to the threaded region before the screw-in process. For additional sealing, an 0-ring is often provided on the side of the screw-in thread of the inner sleeve that is directed outward. Sealing of the connector piece takes place exclusively by way of the aforementioned sealing adhesive.

It is a disadvantage of the previously known outer valves that the medium that flows through comes into contact with the adhesive. Particularly in the sector of drinking water supplies, such contacts with adhesives are subject to various restrictions, on a state-by-state basis. For this reason, different adhesives must be used, depending on the requirements of a specific state. In some states, it is actually foreseeable that such contacts with adhesive will be prohibited in the future.

### SUMMARY OF THE INVENTION

It is an object of the present invention to provide a remedy for these disadvantages and to provide a side valve of the aforementioned type, in which contact of the medium that flows through with the sealing adhesive is precluded. These and other objects are achieved, according to the invention, by disposing a groove for accommodating a sealing ring adjacent to the attachment section of the side valve, on its side facing away from the connector piece.

With the invention, a side valve is created in which contact of the medium that is flowing through with the sealing adhesive is precluded. Contact of the medium that flows through the side valve with the screw-in thread region provided with sealing adhesive is avoided by providing a sealing ring adjacent to the attachment section, on its side facing away from the connector piece. Here, the term attachment section is understood to mean the region in which the connection between outer sleeve and inner sleeve is formed. In the case of a screw connection, this region, for example, is where the threads are in engagement; in the case of a press connection, the contact region is the press fit. Likewise, the attachment section can also be formed by a bead.

In a further aspect of the invention, the inner sleeve projects beyond the connector piece in the assembled state. In this way, the use of upper valve parts having a shorter embodiment is made possible.

In another aspect, a side valve is provided in which a support surface for a sealing ring is disposed at the base of the opening disposed in the outer sleeve, on the side, for accommodating the connector piece. Contact of the medium that flows through the side valve with the connection region between the outer sleeve and the connector piece which is provided with the sealing adhesive is avoided. Contact is avoided by providing a sealing ring on a support surface provided on the base of an opening disposed laterally in the outer sleeve, to accommodate the connector piece.

In an embodiment of the invention, the connector piece has a screw-in thread via which the connector piece can be screwed into an inside thread made in the outer sleeve, on the side. Such a screw connection demonstrates the advantage that it can be corrected during assembly, within tolerance limits, in contrast to a press connection, for example.

In a further embodiment of the invention, the connector piece is configured in cone shape at its end that can be screwed into the outer sleeve. In this way, in the screwed-in state, an accommodation for a sealing ring is formed between the support surface and the cone-shaped end. Because of the cone-shaped configuration, an increasing compression of the sealing ring that was previously introduced at the support surface, under bias, is brought about during the screw-in process. As a result, a good sealing effect is achieved.

In a further aspect of the invention, a circumferential bead is disposed on the outer sleeve, in the region of the connector piece. In this way, the cross-section of the outer sleeve is enlarged in this region, thereby making it possible to implement a sufficiently dimensioned thread despite the provision of a sealing ring.

It is advantageous if an inside thread for screwing in an upper valve part is made in the outer sleeve. In this way, easy assembly of an upper valve part into the outer sleeve is made possible.

### BRIEF DESCRIPTION OF THE DRAWINGS

Other objects and features of the present invention will become apparent from the following detailed description considered in connection with the accompanying drawings. It should be understood, however, that the drawings are designed for the purpose of illustration only and not as a definition of the limits of the invention.

In the drawings, wherein similar reference characters denote similar elements throughout the several views:

FIG. 1 is a partial sectional representation of a side valve;

FIG. 2 is a detail view of the screw-in region of inner sleeve and connector piece of the side valve from FIG. 1; and

FIG. 3 is a partial sectional representation of another embodiment of a side valve with connector piece formed on.

### DETAILED DESCRIPTION OF PREFERRED EMBODIMENTS

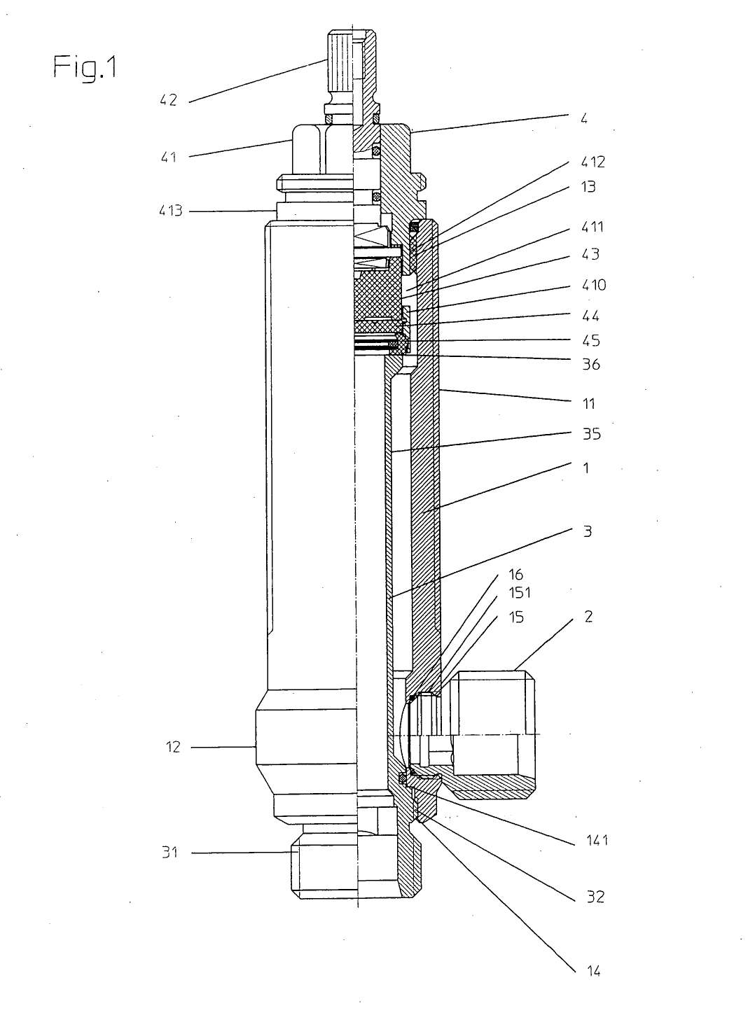

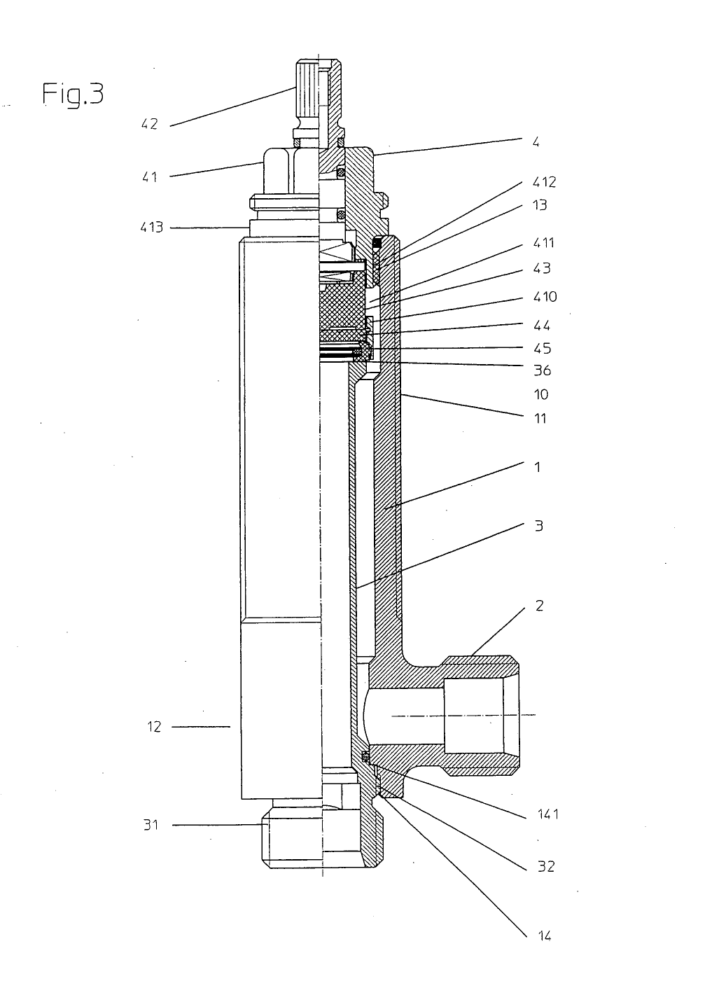

Referring now in detail to the drawings, FIGS. 1-3 show exemplary embodiments of a side valve essentially made up of an outer sleeve 1, a connector piece 2, an inner sleeve 3, and an upper valve part 4.

In the exemplary embodiments, outer sleeve 1 is made of brass and is essentially configured in the shape of a hollow cylinder. Over about ⅔ of the length of outer sleeve 1, an outside thread 11 is made in outer sleeve 1. At a distance from outside thread 11, a bead 12 is formed onto outer sleeve 1, on its circumference. Bead 12 is configured so that it ends in a planar circumferential ring. In this way, a good support surface is achieved for connector piece 2. A circular recess 15 is made in bead 12, orthogonal to bead 12, which recess is provided with an inside thread 151. A support surface 152 for a sealing ring is provided at the base of inside thread 151. At the end of outer sleeve 1 that faces bead 12, an inside thread 14 is furthermore made in the sleeve, at the base of which thread a stop 141 is disposed. Furthermore, at the end that faces away from bead 12, an inside thread 13 for attaching an upper valve part 4 is made on the inside of outer sleeve 1.

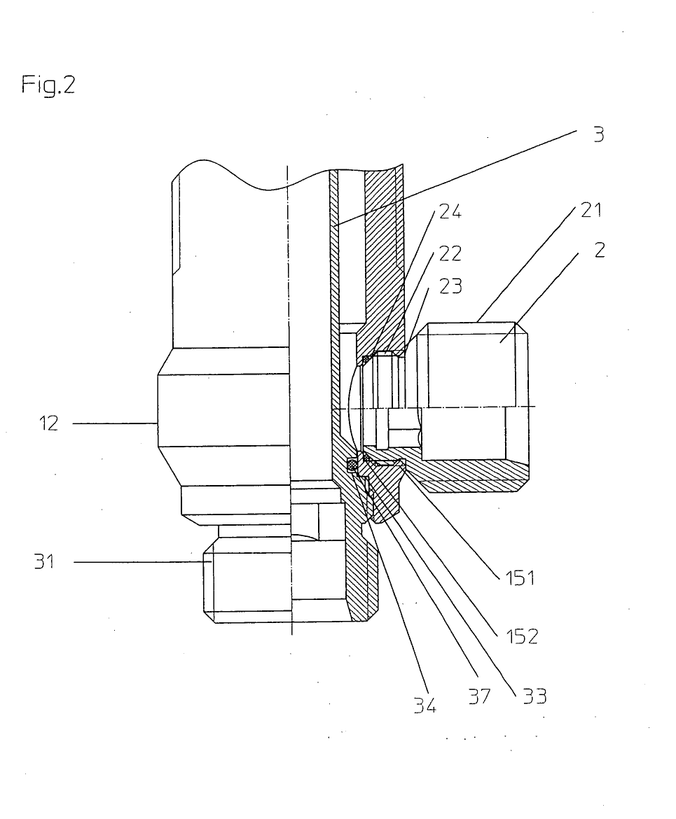

In the exemplary embodiment shown in FIG. 2, connector piece 2 is produced from brass and essentially configured in the shape of a hollow cylinder. A connection thread 21 as well as a screw-in thread 22 are made in its outer mantle surface, on the circumference, spaced apart from one another. A stop 23 in the form of a circumferential ridge is formed on between connection thread 21 and screw-in thread 22, which is structured to be smaller in diameter. At its end facing screw-in thread 22, a circumferential outer cone 24 is formed onto connector piece 2.

Inner sleeve 3 is also structured as a lathed brass part, essentially in the shape of a hollow cylinder. At one end, a connection thread 31 is made in inner sleeve 3, on the circumference. Furthermore, a screw-in thread 32 reduced in diameter is disposed at a distance from connection thread 31. A stop 33 follows screw-in thread 32; this stop is configured as a circumferential ridge followed, in turn, by a circumferential groove 34 for accommodating a sealing ring. A narrowed section 35 borders on groove 34, by way of a conically shaped transition, which section ends in a circumferential collar 36 that serves as a support surface for the upper valve part 4.

Upper valve part 4 used in the exemplary embodiments has a head piece 41 that has a spindle 42 passing through its center, radially guided in it. A valve can be activated by way of spindle 42, which valve comes to rest on the collar 36 of the inner sleeve 3. In the exemplary embodiments, the valve is formed by a control disk 43 and a passage disk 44. Control disk 43 is connected with spindle 42 with shape fit. On the side of control disk 43 that faces away from spindle 42, passage disk 44 is provided in head piece 41, followed by a sealing element 45 that comes to rest on collar 36 of inner sleeve 3.

Head piece 41 is made up of a symmetrical hollow body, the two faces of which are open. On its side facing inner sleeve 3, head piece 41 has a sleeve-like part 410. Passage windows 411 are provided in part 410. Following passage windows 411, head piece 41 can be screwed into the inside thread 13 of outer sleeve 1 with a connection thread 412, on the outside. After it has been screwed in, sealing element 5 of upper valve part 4 rests on collar 36 of inner sleeve 3. Such upper valve parts are known to a person skilled in the art, for example from DE 32 07 895 C2.

During assembly of the side valve, a sealing ring 16 is introduced into the recess 15 of outer sleeve 1, so that it rests on support surface 152 in biased manner. Subsequently, connector piece 2 is provided with adhesive in the region of screw-in thread 22, up to stop 23, and connector piece 2 is screwed into inside thread 151 of recess 15 of outer sleeve 1. As this connection is being done, sealing ring 16 is compressed by way of outer cone 24 of connector piece 2, thereby achieving a good sealing effect.

A sealing ring 37 is laid into groove 34 of inner sleeve 3, under bias. Screw-in thread 32 of inner sleeve 3 is provided with an adhesive up to stop 33, and inner sleeve 3 is screwed into inside thread 14 of outer sleeve 1 with screw-in thread 32, until stop 33 of inner sleeve 3 rests against stop 141 of outer sleeve 1.

Upper valve part 4 is screwed into inside thread 13 of the outer sleeve, with the connection thread 412, so that the sealing element 45 rests on the circumferential collar 36 of inner sleeve 3, forming a seal. In this connection, passage windows 411 open into the interstice formed between outer sleeve 1 and inner sleeve 3.

In the assembled state of the side valve, the medium enters into the side valve through inner sleeve 3. When upper valve part 4 is open, the medium passes through passage windows 411 and flows through the interstice formed between outer sleeve 1 and inner sleeve 3, in the opposite direction, until the medium exits through connector piece 2 in the region of the narrowed section 35 of inner sleeve 3.

Although at least two embodiments have been shown and described, it is understood that many changes and modifications may be made thereunto without departing from the spirit and scope of the invention as defined in the appended claims.

What is claimed is:

1. A side valve comprising:
(a) an outer sleeve;
(b) a connector piece laterally introduced into the said outer sleeve;
(c) an inner sleeve for connecting to a water supply introduced into said outer sleeve;
(d) an attachment section;
(e) a sealing ring;
(f) a groove for accommodating the sealing ring disposed adjacent to the attachment section on a side of the groove facing away from the connector piece.

2. The side valve according to claim 1, wherein the inner sleeve has a screw-in thread for screwing the inner sleeve into the outer sleeve, and the attachment section comprises a screw connection.

3. The side valve according to claim 1, wherein the inner sleeve projects beyond the connector piece in an assembled state of the side valve.

4. A side valve comprising:
(a) an outer sleeve having an opening with a base;
(b) a connector piece received in the opening and affixed into a side of the outer sleeve;
(c) a sealing ring; and
(d) a support surface for the sealing ring disposed at the base of the opening.

5. The side valve according to claim 1, wherein the connector piece has a screw-in thread screwing the connector piece into an inside thread made laterally in the outer sleeve.

6. The side valve according to claim 4, wherein the connector piece comprises a cone-shaped end that can be screwed into the outer sleeve so that in a screwed-in state, an accommodation for the sealing ring is formed between the support surface and the cone-shaped end.

7. The side valve according to claim 1, further comprising a circumferential bead disposed on the outer sleeve near the connector piece.

8. The side valve according to claim 1, further comprising an inside thread made in the outer sleeve for screwing in an upper valve part.
